(19) United States
(12) Patent Application Publication
(10) Pub. No.: US 2026/0141498 A1
(43) Pub. Date: May 21, 2026

(54) DUAL CROP SAMPLING FOR GENERATIVE INPAINTING

(71) Applicant: ADOBE INC., SAN JOSE, CA (US)

(72) Inventor: Yuqian Zhou, Redmond, WA (US)

(21) Appl. No.: 18/954,880

(22) Filed: Nov. 21, 2024

(51) Int. Cl. G06T 5/77; G06T 7/10

(52) U.S. Cl. CPC G06T 5/77; G06T 7/10; G06T 2207/20132

(57) ABSTRACT

A system, apparatus, method or non-transitory computer readable medium may include obtaining an input image and an inpainting indication, wherein the input image depicts a scene and the inpainting indication indicates a region of the scene to be inpainted and generating, using an image generation model, an intermediate inpainting result based on a global context of the input image. The image generation model then generates an inpainted image based on the intermediate inpainting result and a local context of the input image that includes a smaller portion of the input image than the global context, where the inpainted image depicts the scene with synthetic content in the region indicated by the inpainting indication.

### BACKGROUND

The following relates generally to image processing, and more specifically to image generation and inpainting. Image processing refers to the use of a computer to create or edit an image using an algorithm or a processing network. Image processing software can be used for various image processing tasks, such as image restoration, image detection, image editing, image compositing, and image generation.

Machine learning models including deep neural networks may be used to generate images or parts of images. However, when a machine learning model generates part of an image, the generated part may not be consistent with original parts of the image. This results in an unnatural appearance.

### SUMMARY

Aspects of the disclosure relate to image processing using machine learning. An image generation model is used to perform an inpainting task. The inpainted portion is generated to be consistent with parts of the original image. In some embodiments, the inpainting is performed using a diffusion model that denoises a noise input to generate the inpainted content. The denoising process can be performed in two or more stages. In the first stage (e.g., including a first set of denoising timesteps), the denoising is performed with a global context to ensure consistency with the original image. In a second stage (e.g., including a second set of denoising timesteps) the denoising is performed with a local context.

A method, system, non-transitory computer readable medium, and system1 for image generation are described. One or more aspects of the method, system, non-transitory computer readable medium, and system include obtaining an input image and an inpainting indication, wherein the input image depicts a scene and the inpainting indication indicates a region of the scene to be inpainted; generating, using an image generation model, an intermediate inpainting result based on a global context of the input image; and generating, using the image generation model, an inpainted image based on the intermediate inpainting result and a local context of the input image that includes a smaller portion of the input image than the global context, wherein the inpainted image depicts the scene with synthetic content in the region indicated by the inpainting indication.

A method, system, non-transitory computer readable medium, and system1 for image generation are described. One or more aspects of the method, system, non-transitory computer readable medium, and system include obtaining an input image and an inpainting indication, wherein the input image depicts a scene and the inpainting indication indicates a region of the scene to be inpainted; generating, using an image generation model, an intermediate inpainting result at a first scale; and generating, using the image generation model, an inpainted image at a second scale that is smaller than the first scale based on the intermediate inpainting result, wherein the inpainted image depicts the scene with the synthetic content in the region indicated by the inpainting indication at a higher level of detail than in the intermediate inpainting result.

### BRIEF DESCRIPTION OF THE DRAWINGS

FIG. 1 shows an example of a system for image processing according to aspects of the present disclosure.

FIG. 2 shows an example of inconsistent images according to aspects of the present disclosure.

FIG. 3 shows an example of local crop and dual-crop sampling according to aspects of the present disclosure.

FIG. 4 shows an example of a method of image processing according to aspects of the present disclosure.

FIG. 5 shows an example of dual crop sampling according to aspects of the present disclosure.

FIG. 6 shows an example of a guided diffusion model according to aspects of the present disclosure.

FIG. 7 shows an example of a U-Net according to aspects of the present disclosure.

FIG. 8 shows an example of a method for conditional media generation according to aspects of the present disclosure.

FIG. 9 shows a diffusion process according to aspects of the present disclosure.

FIG. 10 shows a flow diagram depicting an algorithm as a step-by-step procedure for training a machine-learning model according to aspects of the present disclosure.

FIG. 11 shows an example of a method for training a diffusion model according to aspects of the present disclosure.

FIG. 12 shows an example of a computing device according to aspects of the present disclosure.

FIG. 13 shows an example of an image generation apparatus according to aspects of the present disclosure.

### DETAILED DESCRIPTION

Aspects of the disclosure relate to image processing using machine learning. In some embodiments, an image generation model is used to perform inpainting. Inpainting refers to an image processing task where a portion of an image is filled with new content. For example, an image generation model can generate the novel content in a location indicated by an inpainting mask. Other portions of the image can remain the same or similar to the original.

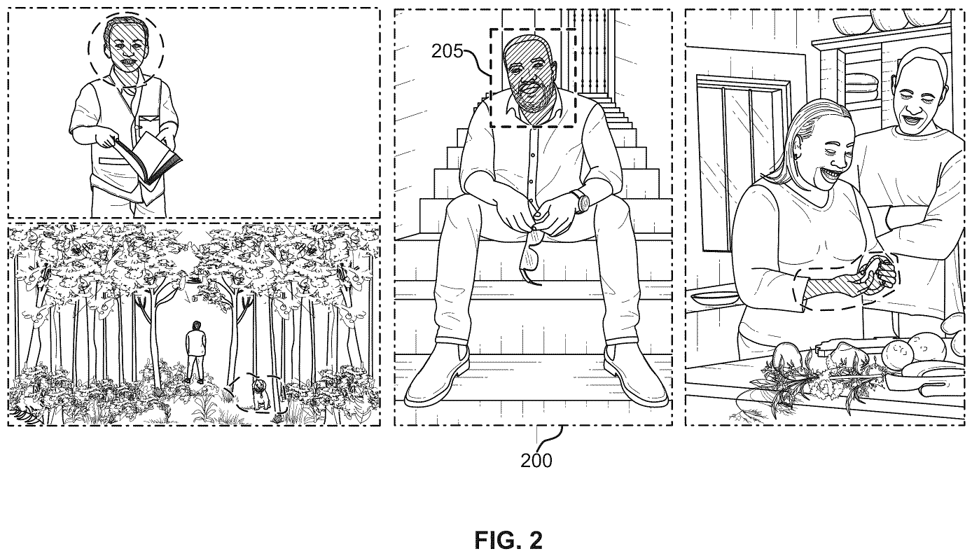

Conventional image generation models generate can content for an inpainting task, but the generated content is often inconsistent with the original. For example, the skin color of the generated content can be different from the skin color of a person in the original, as in FIG. 2. This results in an overall inconsistency in the resulting inpainted image. Furthermore, taking a larger portion of the original image as context during image generation can result in a reduction in the level of detail that is generated by the image generation model.

Embodiments of the present disclosure improve on conventional image generation models by more accurately generating inpainted to be content consistent with original content of an input image. By performing a diffusion process in multiple stages, where some stages use a global context and other stages use a local context, an image generation model performs inpainting that consistently matches the global context. Furthermore, by performing some stages with a local context, embodiments generate output with a high degree of detail.

In some embodiments, the inpainting is performed using a diffusion model that denoises a noise input to generate the inpainted content. The denoising process can be performed in two stages. In the first stage (e.g., including a first set of denoising timesteps), the denoising is performed with a global context to ensure consistency with the original image. In the second stage (e.g., including a second set of denoising timesteps) the denoising is performed with a local context. The global context can be a crop that includes the entire original image or a portion of it. The local context can include an image crop that includes a smaller portion of the original image, e.g., a subset of the global crop. In some cases, the global crop and the local crop can be scaled differently so that they both match the target input size of the image generation model.

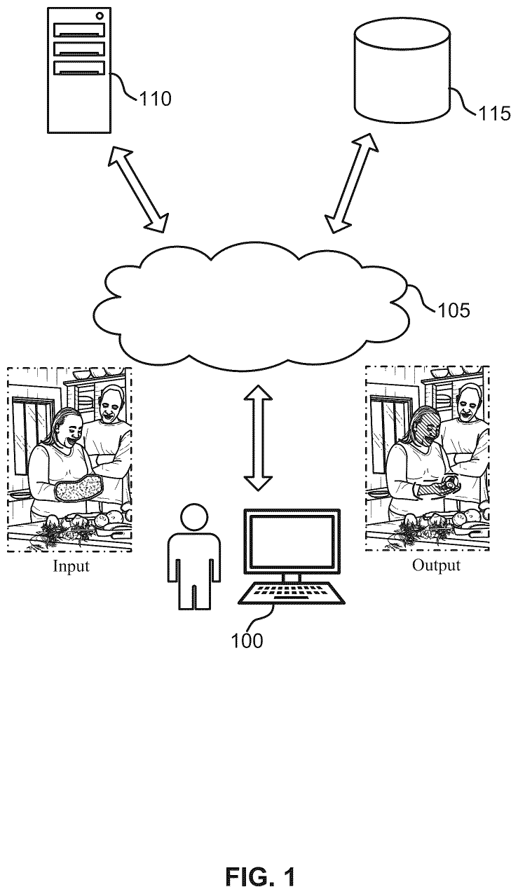

FIG. 1 shows an example of a system for image processing according to aspects of the present disclosure. The example shown includes user device 100, cloud 105, server 110, and database 115. A user provides, via user device 100, an input including an image and an indication of a region to be inpainted. The user device can perform the inpainting locally or send the inputs via the cloud 105 to a server 110 that performs the inpainting. In some cases, the user accesses or stores the inputs or outputs in a database 115.

A cloud 105 is a computer network configured to provide on-demand availability of computer system resources, such as data storage and computing power. In some examples, the cloud 105 provides resources without active management by the user. The term cloud 105 is sometimes used to describe data centers available to many users over the Internet. Some large cloud 105 networks have functions distributed over multiple locations from central servers 110. A server 110 is designated an edge server 110 if it has a direct or close connection to a user. In some cases, a cloud 105 is limited to a single organization. In other examples, the cloud 105 is available to many organizations. In one example, a cloud 105 includes a multi-layer communications network comprising multiple edge routers and core routers. In another example, a cloud 105 is based on a local collection of switches in a single physical location.

The user device 100 may be a personal computer, laptop computer, mainframe computer, palmtop computer, personal assistant, mobile device, a smart hub, or any other suitable processing apparatus. In some examples, the user device 100 includes software that performs contextualized image generation and inpainting. The question answering application may either include or communicate with the event argument extraction apparatus.

A database 115 is an organized collection of data. For example, a database 115 stores data in a specified format known as a schema. A database 115 may be structured as a single database 115, a distributed database 115, multiple distributed databases 115, or an emergency backup database 115. In some cases, a database 115 controller may manage data storage and processing in a database 115. In some cases, a user interacts with database 115 controller. In other cases, database 115 controller may operate automatically without user interaction.

A server 110 provides one or more functions to users linked by way of one or more of the various networks. In some cases, the server 110 includes a single microprocessor board, which includes a microprocessor responsible for controlling all aspects of the server 110. In some cases, a server 110 uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server 110 is configured to send and receive hypertext markup language (HTML) formatted files (e.g., for displaying web pages). In various embodiments, a server 110 comprises a general-purpose computing device, a personal computer, a laptop computer, a mainframe computer, a super computer, or any other suitable processing apparatus.

User device 100 or server 110 may include an artificial neural network (ANN) for performing inpainting. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

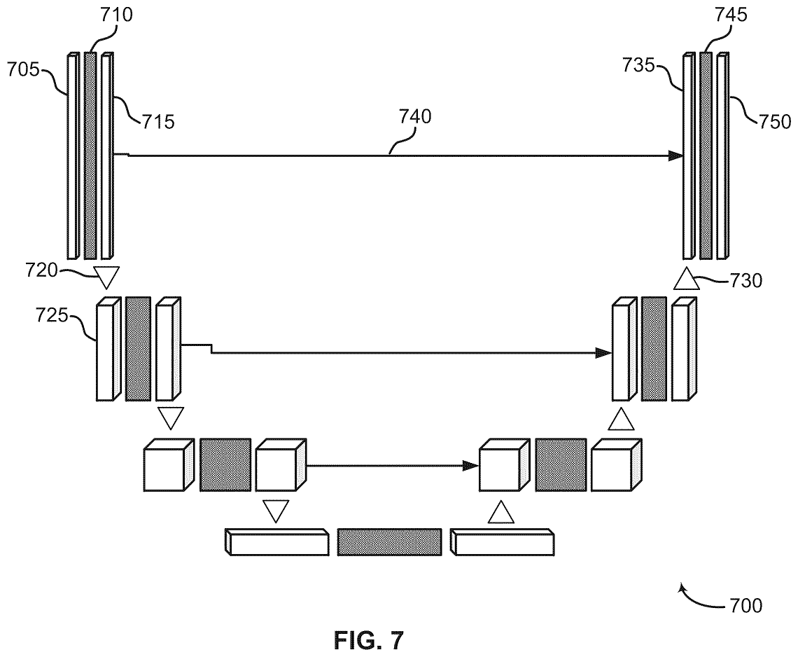

The ANN may include one or more convolutional neural network (CNN) layers (e.g., as part of a UNet arrangement as shown in FIG. 7). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

FIG. 2 shows an example of inconsistent images according to aspects of the present disclosure. The images 200 depicted are examples of images output by an image generation model that does not incorporate global context in the image generation. In each example, an image 200 (indicated by a dash-dot line) has an inpainted region 205 (indicated by a dashed line) that is inconsistent with other parts of the image. For example, the skin color or lighting of generated content can be inconsistent with the context of the image. In other examples, other textures generated by an image generation model can be inconsistent with other regions of an image to be inpainted.

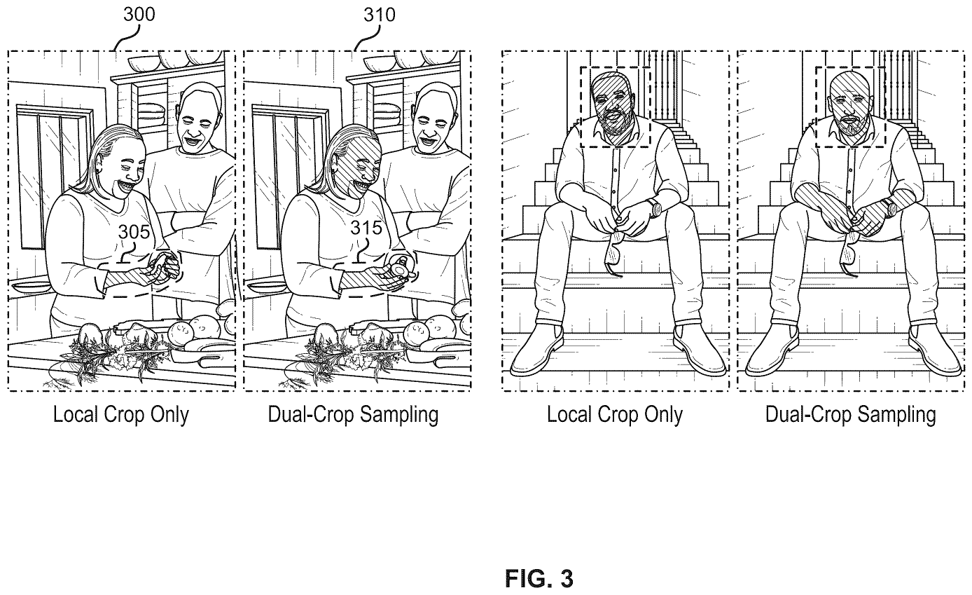

FIG. 3 shows an example of local crop and dual-crop sampling according to aspects of the present disclosure. The example shown includes local crop image 300 and dual crop image 310. Local crop image 300 is generated using a small image crop (e.g., a bounding box around the region to be inpainted). This results in an output where the inpainted content 305 has textures (e.g., skin color, lighting, material texture, etc.) that are not consistent with the overall context of the image.

By contrast, dual crop image 310 shows an output where the inpainted region 315 is consistent with the overall context of the image. That is, generated textures within the inpainted region are consistent with the context of the image. Dual crop image 310 is an example of an image generated using the systems and methods described herein.

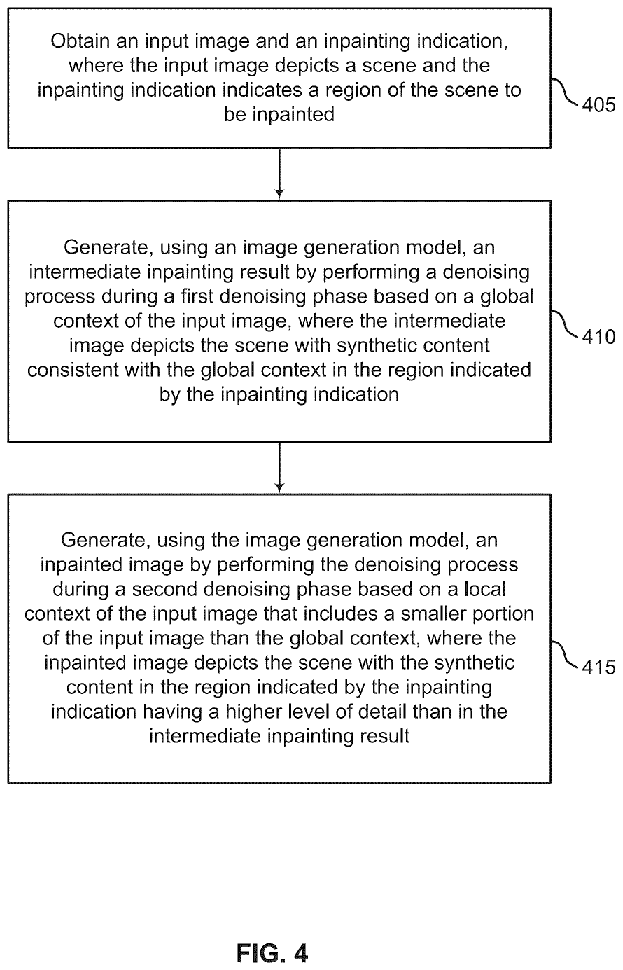

FIG. 4 shows an example of a method 400 of image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

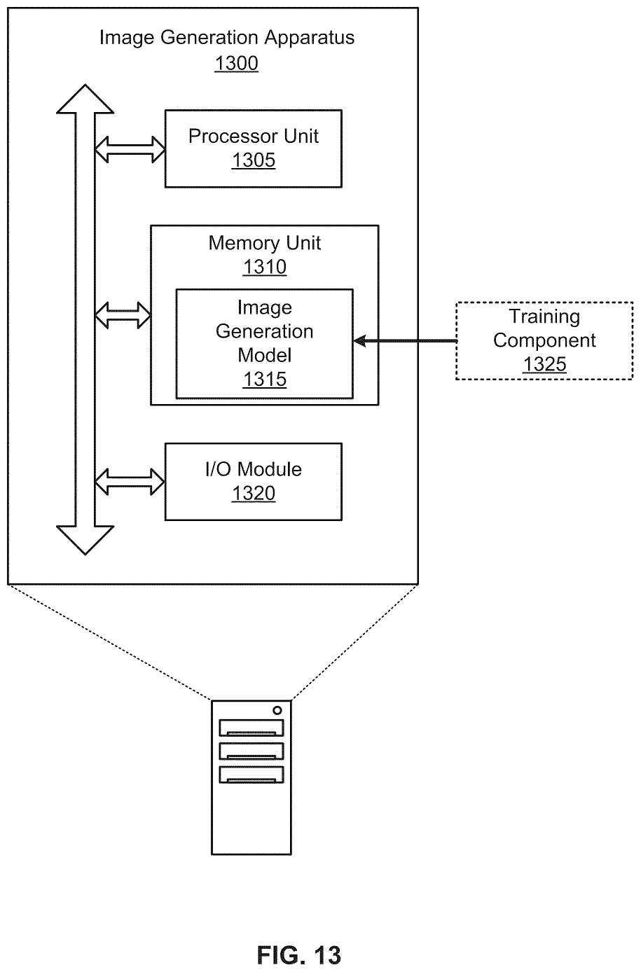

At operation 405, the system obtains an input image and an inpainting indication, where the input image depicts a scene and the inpainting indication indicates a region of the scene to be inpainted. For example, the inpainting region could be represented by a mask or a layer provided by a user that marks an area to be inpainted. In some cases, the operations of this step refer to, or may be performed by, an image generation apparatus as described with reference to FIG. 13.

Accordingly, dual-sampling inpainting may include obtaining an input image/and an inpainting indication represented by a mask region M, cropping the image/and the mask region M using a first scale factor s1 and a second scale factor s2, where scale s1 yields a global crop while scale S2 yields a local crop and first scale factor numerically larger than second scale factor S2. The image/and mask region M can be represented in pixels.

At operation 410, an image generation model generates an intermediate inpainting result by performing a denoising process during a first denoising phase based on a global context of the input image, where the intermediate image depicts the scene with synthetic content consistent with the global context in the region indicated by the inpainting indication. The global context can be crop based on scale s1. In some cases, the operations of this step refer to, or may be performed by, an image generation apparatus as described with reference to FIG. 13.

At operation 415, the system generates, using the image generation model, an inpainted image by performing the denoising process during a second denoising phase based on a local context of the input image that includes a smaller portion of the input image than the global context, where the inpainted image depicts the scene with the synthetic content in the region indicated by the inpainting indication having a higher level of detail than in the intermediate inpainting result. For example, the second denoising phase can use a local crop based on scale S2. In some cases, the operations of this step refer to, or may be performed by, an image generation apparatus as described with reference to FIG. 13.

The sampling method may include running the inpainting model on the global crop which encompasses both the image I and mask region M, at the first scale factor S1. During sampling in the global crop step, the model would consider the global context of the images, context including but not limited to global color tones, human skin tones, image lightning, repeating textures and patterns etc., to fill in the hole region with an appropriate structure and matched color tones based on the global context, and the sampling is performed iteratively for up to T iterations.

The inpainting model generates a prediction result based on the global crop in turn based on global context for each iteration. The iteration results from T iterations applied to the global image will then serve as the initialization parameter for the local inpainting step. Examples of inpainting models include pixel diffusion model, latent diffusion model etc. where for a pixel diffusion model, a pixel-space x, prediction model and for a latent diffusion model, latent-space x, prediction model could be employed.

Based on the prediction results of the selected diffusion model, the sampling is performed again to spatially align the local image and the crop and to fill in the hole because of the initialization process. Thus, dual-sampling helps resolve discrepancies in skin-tone, allowing for high-resolution inpainting, where in the hole to be inpainted, is cropped in a localized region with limited global context. While the dual-sampling method includes an inference-time algorithm applied diffusion-based model, the method can be extended to inpainting models trained in a traditional manner would have similar inference time as conventional sampling processes.

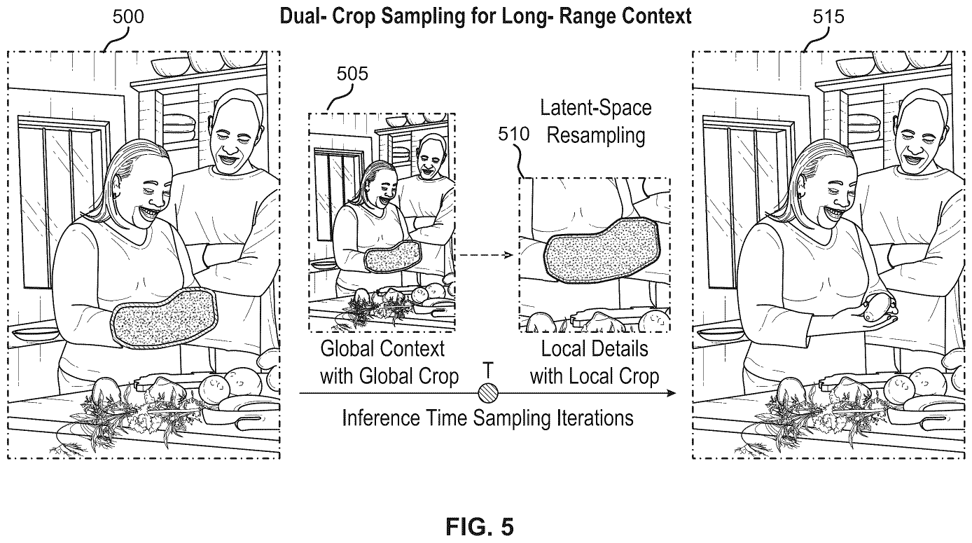

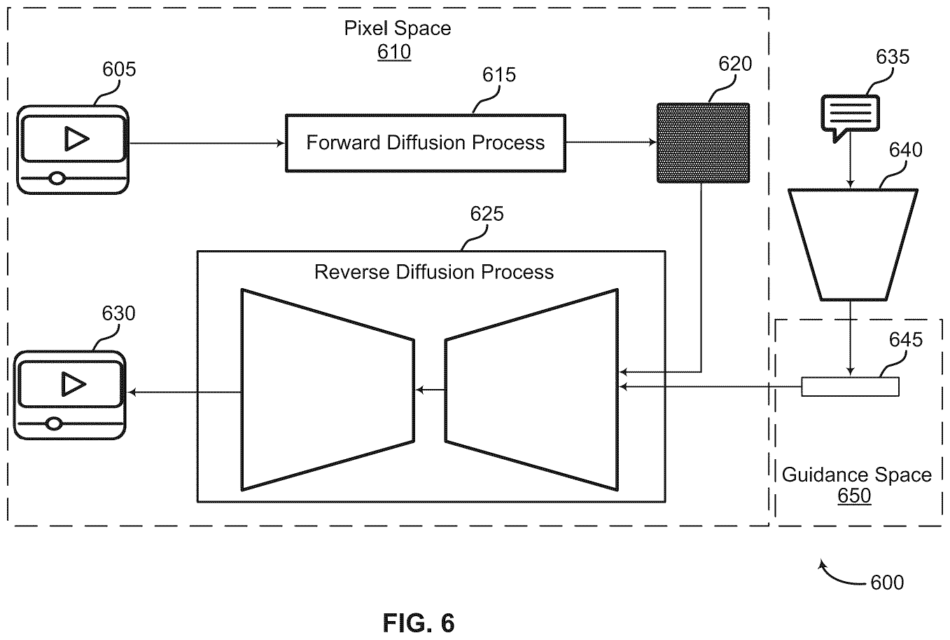

FIG. 5 shows an example of dual crop sampling according to aspects of the present disclosure. The example of dual crop sampling shown in FIG. 5 includes multiple stages. First, inputs 500 may be obtained, including an original image and a region to be inpainted. Then, during a first diffusion stage, a global crop 505 may be used as guidance for the diffusion process described below with reference to FIGS. 6-9. The first diffusion stage may include one or more diffusion timesteps corresponding to different passes of an image generation model.

Next, during a second diffusion stage a local crop 510 with a different scale than the global crop 505 can be used to generate finer details for the inpainted region to produce output image 515. The second diffusion stage can include one or more timesteps after the first diffusion stage, although in some embodiments the first diffusion stage and the second diffusion stage overlap (i.e., multiple images or an intermediate context can be used during the overlap period).

Performing the first stage with the global crop 505 can ensure the consistency of the inpainted region with the overall image which performing a second stage with local crop 510 can enable a higher level of detail to be generated, thus balancing the need for consistency and detail. In some cases, an intermediate output can be rescaled in between the global crop stages and the local crop stages to ensure consistency.

FIG. 6 shows an example of a guided diffusion model 600 according to aspects of the present disclosure. In some examples, guided diffusion model 600 describes the operation and architecture of the image generation model 1315 described with reference to FIG. 13. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 630 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

In some cases, an image may be used for guidance, such as a global context image or a local context image as described above. For example, during a first diffusion stage a global context image may be used to generated guidance features 645 or additional guidance features and then during a second diffusion stage stages a localized portion of an image (i.e., the local context image) may be used to generated guidance features 645. In some cases, both an image and text can be used as guidance. In some cases, the global and local context images are used to ensure that pixels or latents representing the generated content match the context image in regions other than an inpainting region indicated by an inpainted mask. In some cases, the mask is scaled differently for application to the global context and local context (i.e., as the scale of the images are different). In some cases, an intermediate result is rescaled after the first diffusion stage for use as input to the second diffusion stage with different guidance.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

FIG. 7 shows an example of a U-Net 700 according to aspects of the present disclosure. In some examples, U-Net 700 is an example of the component that performs the reverse diffusion process 625 of guided diffusion model 600 described with reference to FIG. 6 and includes architectural elements of the image generation model 1315 described with reference to FIG. 13. The U-Net 700 depicted in FIG. 7 is an example of, or includes aspects of, the architecture used within the reverse diffusion process described with reference to FIG. 6.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having the same resolution and number of channels via a skip connection 740. These inputs are processed using a final neural network layer 745 to produce output features 750. In some cases, the output features 750 have the same resolution as the initial resolution and the same number of channels as the initial number of channels.

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715.

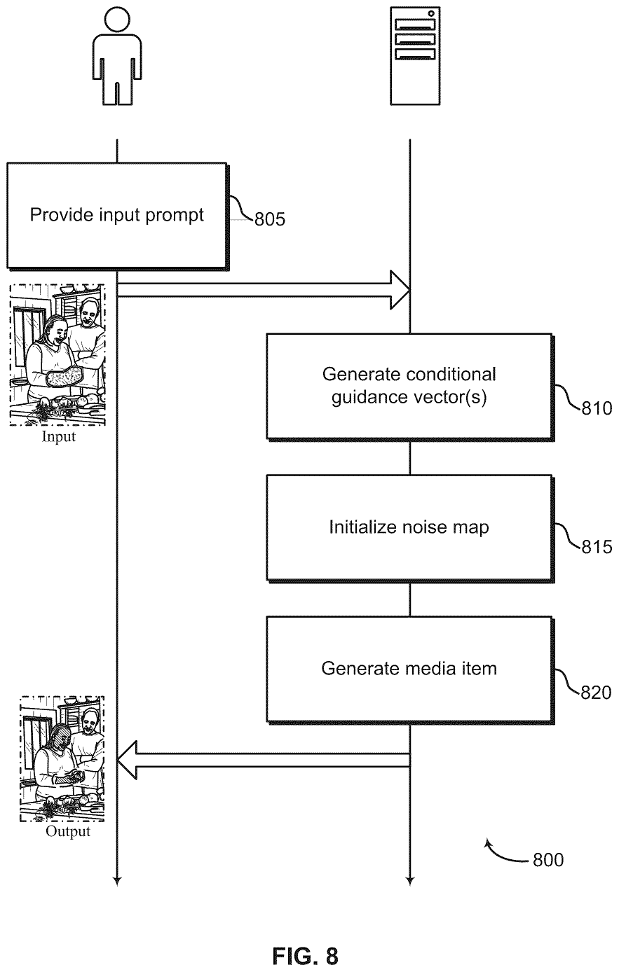

FIG. 8 shows an example of a method 800 for conditional media generation according to aspects of the present disclosure. In some examples, method 800 describes an operation of the image generation model 1315 described with reference to FIG. 13 such as an application of the guided diffusion model 600 described with reference to FIG. 6. In some examples, these operations are performed by a system including a processor executing a set of codes to control functional elements of an apparatus such as the media generation model described in FIG. 6.

Additionally or alternatively, steps of the method 800 may be performed using special-purpose hardware. Generally, these operations are performed according to the methods and processes described in accordance with aspects of the present disclosure. In some cases, the operations described herein are composed of various substeps or are performed in conjunction with other operations.

At operation 805, a user provides a text prompt describing content to be included in a generated media item. For example, a user may provide the prompt “a person playing with a cat”. In some examples, guidance can be provided in a form other than text, such as via an image, a sketch, or a layout.

At operation 810, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 815, a noise map is initialized that includes random noise. The noise map may be in a pixel space or a latent space. By initializing a media item with random noise, different variations of a media item including the content described by the conditional guidance can be generated.

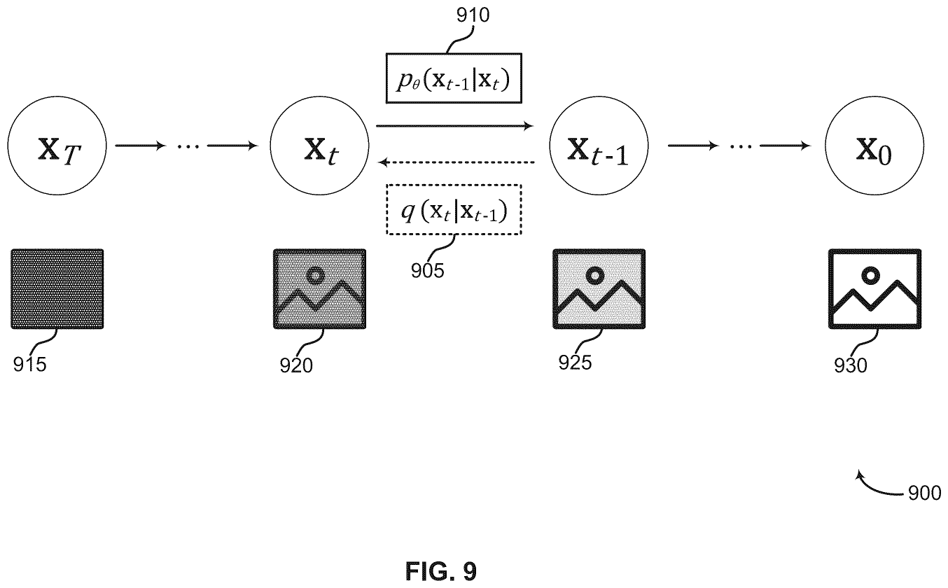

At operation 820, the system generates a media item based on the noise map and the conditional guidance vector. For example, the media item may be generated using a reverse diffusion process as described with reference to FIG. 9.

FIG. 9 shows a diffusion process 900 according to aspects of the present disclosure. In some examples, diffusion process 900 describes an operation of the image generation model 1315 described with reference to FIG. 13, such as the reverse diffusion process 625 of guided diffusion model 600 described with reference to FIG. 6.

As described above with reference to FIG. 6, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x, (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x_{T} reverts back to x₀, the original media item 930. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x, in a pixel space can be mapped into a latent space as input and a generated data \tilde{x} is mapped back into the pixel space from the latent space as output. In some examples, x, represents an original input media item with low quality, latent variables x₁, . . . , x_{T} represent noisy media items, and x represents the generated item with high quality.

### Training: Machine Learning

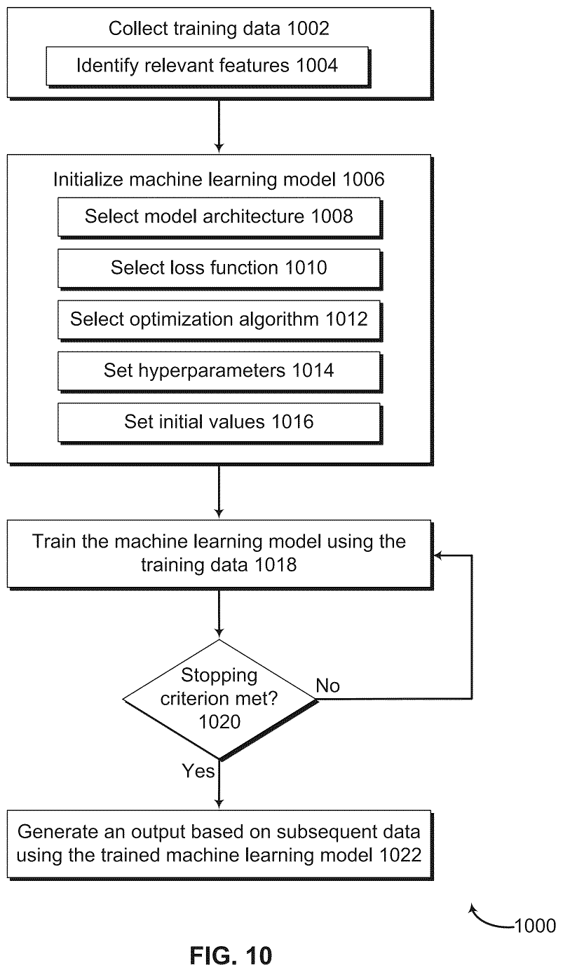

FIG. 10 is a flow diagram depicting an algorithm as a step-by-step procedure 1000 in an example implementation of operations performable for training a machine-learning model. In some embodiments, the procedure 1000 describes an operation of the training component 1325 described for configuring the image generation model 1315 as described with reference to FIG. 13. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained it is configured to perform that task based on subsequent data received as an input and processed by the machine-learning model.

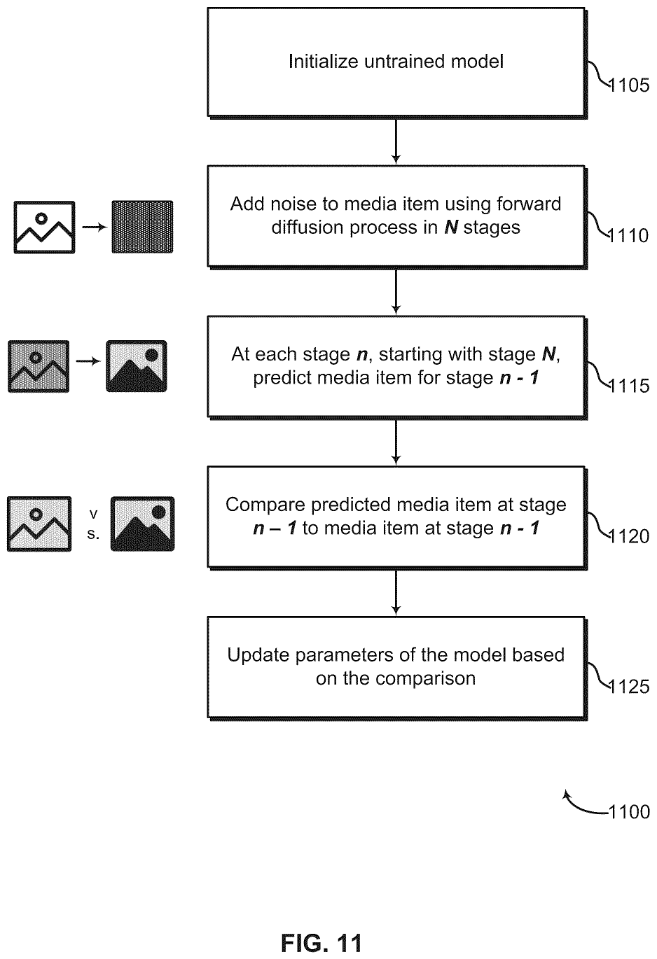

FIG. 11 shows an example of a method 1100 for training a diffusion model according to aspects of the present disclosure. In some embodiments, the method 1100 describes an operation of the training component 1325 described for configuring the image generation model 1315 as described with reference to FIG. 13. The method 1100 represents an example for training a reverse diffusion process as described above with reference to FIG. 9. In some examples, these operations are performed by a system including a processor executing a set of codes to control functional elements of an apparatus, such as the guided diffusion model described in FIG. 1.

Additionally or alternatively, certain processes of method 1100 may be performed using special-purpose hardware. Generally, these operations are performed according to the methods and processes described in accordance with aspects of the present disclosure. In some cases, the operations described herein are composed of various substeps or are performed in conjunction with other operations.

At operation 1105, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1110, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1115, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1120, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1125, the system updates parameters of the model based on the comparison. For example, parameters of a U-Net may be updated using gradient descent. Time-dependent parameters of the Gaussian transitions can also be learned.

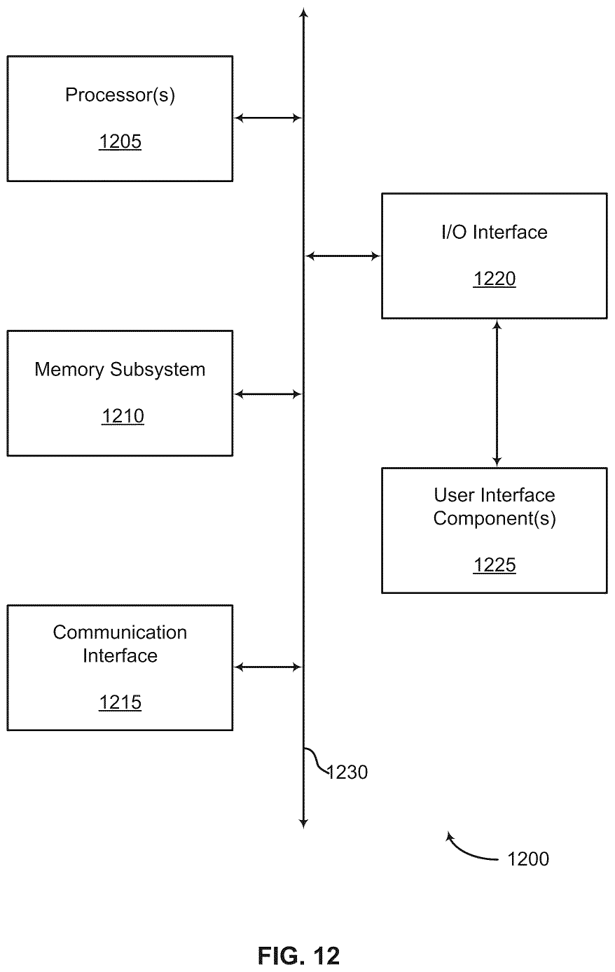

FIG. 12 shows an example of a computing device 1200 according to aspects of the present disclosure. The computing device 1200 may be an example of the image generation apparatus 1300 described with reference to FIG. 13. In one aspect, computing device 1200 includes processor(s) 1205, memory subsystem 1210, communication interface 1215, I/O interface 1220, user interface component(s) 1225, and channel 1230.

In some embodiments, computing device 1200 is an example of, or includes aspects of, the media generation model of FIG. 1. In some embodiments, computing device 1200 includes one or more processors 1205 that can execute instructions stored in memory subsystem 1210 to perform media generation.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

FIG. 13 shows an example of an image generation apparatus 1300 according to aspects of the present disclosure. image generation apparatus 1300 may include an example of, or aspects of, the guided diffusion model described with reference to FIG. 6 and the U-Net described with reference to FIG. 7. In some embodiments, image generation apparatus 1300 includes processor unit 1305, memory unit 1310, image generation model 1315, I/O module 1320, and training component 1325. Training component 1325 updates parameters of the image generation model 1315 stored in memory unit 1310. In some examples, the training component 1325 is located outside the image generation apparatus 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors described with reference to FIG. 12.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory subsystem 1210 described with reference to FIG. 12.

According to some aspects, image generation apparatus 1300 uses one or more processors of processor unit 1305 to execute instructions stored in memory unit 1310 to perform functions described herein. For example, the image generation apparatus 1300 may perform inpainting and image generation.

The memory unit 1310 may include an image generation model 1315 trained to perform inpainting and image generation. For example, after training, the image generation model 1315 may perform inferencing operations as described with reference to FIGS. 3 and 9 to perform inpainting and image generation.

In some embodiments, the image generation model 1315 is an Artificial neural network (ANN) such as the guided diffusion model described with reference to FIG. 6 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train the image generation model 1315. For example, parameters of the image generation model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 5 and 11). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1315 can be used to make predictions on new, unseen data (i.e., during inference).

I/O module 1320 receives inputs from and transmits outputs of the image generation apparatus 1300 to other devices or users. For example, I/O module 1320 receives inputs for the image generation model 1315 and transmits outputs of the image generation model 1315. According to some aspects, I/O module 1320 is an example of the I/O interface 1220 described with reference to FIG. 12.

Accordingly, the present disclosure includes the following aspects.

A method for image generation is described. One or more aspects of the method include obtaining an input image and an inpainting indication, wherein the input image depicts a scene and the inpainting indication indicates a region of the scene to be inpainted; generating, using an image generation model, an intermediate inpainting result by performing a denoising process during a first denoising phase based on a global context of the input image, wherein the intermediate image depicts the scene with synthetic content consistent with the global context in the region indicated by the inpainting indication; and generating, using the image generation model, an inpainted image by performing the denoising process during a second denoising phase based on a local context of the input image that includes a smaller portion of the input image than the global context, wherein the inpainted image depicts the scene with the synthetic content in the region indicated by the inpainting indication having a higher level of detail than in the intermediate inpainting result.

Some examples of the method, system, non-transitory computer readable medium, and system1 further include identifying a first scale factor and a second scale factor that is smaller than the first scale factor, wherein the global context is based on the first scale factor and the local context is based on the second scale factor.

Some examples of the method, system, non-transitory computer readable medium, and system1 further include cropping the input image based on the first scale factor to obtain the global context. Some examples further include cropping the input image based on the second scale factor to obtain the local context.

Some examples of the method, system, non-transitory computer readable medium, and system1 further include generating a first inpainting mask based on the inpainting indication and the first scale, wherein the intermediate inpainting result is generated based on the first inpainting mask. Some examples further include generating a second inpainting mask based on the inpainting indication and the second scale, wherein the inpainted image is generated based on the second inpainting mask.

In some aspects, the global context and the local context comprise regions of the input image including the region of the scene to be inpainted. Some examples of the method, system, non-transitory computer readable medium, and system1 further include generating the intermediate inpainting result comprises identifying an intermediate diffusion timestep, wherein the first denoising phase includes a first plurality of denoising iterations performed prior to the intermediate diffusion timestep. In some aspects, the second denoising phase includes a second plurality of denoising iterations performed beginning from the intermediate diffusion timestep.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an inpainting indication, wherein the input image depicts a scene and the inpainting indication indicates a region of the scene to be inpainted;
generating, using an image generation model, an intermediate inpainting result based on a global context of the input image; and
generating, using the image generation model, an inpainted image based on the intermediate inpainting result and a local context of the input image, wherein the inpainted image depicts the scene with synthetic content in the region indicated by the inpainting indication.

2. The method of claim 1, further comprising:
identifying a first scale factor and a second scale factor that is smaller than the first scale factor, wherein the global context is based on the first scale factor and the local context is based on the second scale factor.

3. The method of claim 2, further comprising:
cropping the input image based on the first scale factor to obtain the global context; and
cropping the input image based on the second scale factor to obtain the local context.

4. The method of claim 1, further comprising:
generating a first inpainting mask based on the inpainting indication and the first scale, wherein the intermediate inpainting result is generated based on the first inpainting mask; and
generating a second inpainting mask based on the inpainting indication and the second scale, wherein the inpainted image is generated based on the second inpainting mask.

5. The method of claim 1, wherein:
the intermediate inpainting result is generated by performing a first denoising process during a first denoising phase and depicts the scene with synthetic content consistent with the global context in the region indicated by the inpainting indication; and
the inpainted image is generated by performing the denoising process during a second denoising phase, and wherein the inpainted image includes the synthetic content with a higher level of detail than in the intermediate inpainting result.

6. The method of claim 1, wherein generating the intermediate inpainting result comprises:
identifying an intermediate diffusion timestep, wherein the first denoising phase includes a first plurality of denoising iterations performed prior to the intermediate diffusion timestep.

7. The method of claim 6, wherein:
the second denoising phase includes a second plurality of denoising iterations performed beginning from the intermediate diffusion timestep.

8. The method of claim 6, wherein:
the image generation model is trained to generate images at a first scale factor corresponding to the global context and at second scale factor corresponding to the local context.

9. A non-transitory computer readable medium storing code for image processing, the code comprising instructions that, when executed by at least one processor, cause the at least one processor to perform operations comprising:
obtaining an input image and an inpainting indication, wherein the input image depicts a scene and the inpainting indication indicates a region of the scene to be inpainted;
generating, using an image generation model, an intermediate inpainting result at a first scale; and
generating, using the image generation model, an inpainted image at a second scale that is smaller than the first scale based on the intermediate inpainting result, wherein the inpainted image depicts the scene with the synthetic content in the region indicated by the inpainting indication at a higher level of detail than in the intermediate inpainting result.

10. The non-transitory computer readable medium of claim 9, the code further comprising instructions that, when executed by the at least one processor, cause the at least one processor to perform operations comprising:
cropping the input image based on the first scale factor to obtain a global context, wherein the intermediate inpainting result is generated based on the global context; and
cropping the input image based on the second scale factor to obtain a local context, wherein the inpainted image is generated based on the local context.

11. The non-transitory computer readable medium of claim 9, the code further comprising instructions that, when executed by the at least one processor, cause the at least one processor to perform operations comprising:
generating a first inpainting mask based on the inpainting indication and the first scale, wherein the intermediate inpainting result is generated based on the first inpainting mask; and
generating a second inpainting mask based on the inpainting indication and the second scale, wherein the inpainted image is generated based on the second inpainting mask.

12. The non-transitory computer readable medium of claim 9, wherein:
the intermediate inpainting result is generated based on a global context and the inpainted image is generated based on local context, and wherein the global context and the local context both comprise regions of the input image including the region of the scene to be inpainted.

13. The non-transitory computer readable medium of claim 9, wherein:
the an intermediate inpainting result is generated during a first denoising phase by identifying an intermediate diffusion timestep, wherein the first denoising phase includes a first plurality of denoising iterations performed prior to the intermediate diffusion timestep.

14. The non-transitory computer readable medium of claim 13, wherein:
the inpainted image is generated during a second denoising phase that includes a second plurality of denoising iterations performed beginning from the intermediate diffusion timestep.

15. A system comprising:
a memory component;
a processing device coupled to the memory component, wherein the processing device is configured to execute instructions stored in the memory component to perform operations comprising; and
obtaining an input image and an inpainting indication, wherein the input image depicts a scene and the inpainting indication indicates a region of the scene to be inpainted;
generating, using an image generation model, an intermediate inpainting result based on a global context of the input image; and
generating, using the image generation model, an inpainted image based on the intermediate inpainting result and a local context of the input image that includes a smaller portion of the input image than the global context, wherein the inpainted image depicts the scene with synthetic content in the region indicated by the inpainting indication.

16. The system of claim 15, wherein the processing device is configured to perform operations comprising:
identifying a first scale factor and a second scale factor that is smaller than the first scale factor, wherein the global context is based on the first scale factor and the local context is based on the second scale factor.

17. The system of claim 16, wherein the processing device is configured to perform operations comprising:
cropping the input image based on the first scale factor to obtain the global context; and
cropping the input image based on the second scale factor to obtain the local context.

18. The system of claim 15, wherein the image generation model is configured to perform operations comprising:
generating a first inpainting mask based on the inpainting indication and the first scale, wherein the intermediate inpainting result is generated based on the first inpainting mask; and
generating a second inpainting mask based on the inpainting indication and the second scale, wherein the inpainted image is generated based on the second inpainting mask.

19. The system of claim 15, wherein the processing device is configured to perform operations comprising:
identifying an intermediate diffusion timestep, wherein the intermediate inpainting result is generated using a first denoising process that includes a first plurality of denoising iterations performed prior to the intermediate diffusion timestep and the inpainting image is generated using a second denoising process that includes a second plurality of denoising iterations performed beginning from the intermediate diffusion timestep.

20. The system of claim 15, wherein the image generation model comprises a diffusion UNet.
